(19) United States
(12) Patent Application Publication
(10) Pub. No.: US 2009/0133305 A1
(43) Pub. Date: May 28, 2009

(54) Label holder for suspension file and suspension file fitted with such a label holder

(75) Inventors: Yves Calistri, Lyon (FR); Philippe Sol, Lyon (FR)

Correspondence Address: Ralph A. Dowell of DOWELL & DOWELL P.C., 2111 Eisenhower Ave, Suite 406, Alexandria, VA, 22314, US

(73) Assignee: L'OBLIQUE, Villeurbanne (FR)

(21) Appl. No.: 12/222,460

(22) Filed: Aug. 8, 2008

(30) Foreign Application Priority Data
Aug. 10, 2007 (FR) 07 05818

(51) Int. Cl. G09F 3/18; B65D 27/00

(52) U.S. Cl. 40/651; 229/67.2

(57) ABSTRACT

This label holder (5) for a suspension file (1), comprises a body (51) having means (54) for attachment to a side wall (3) of the file and a reader (52) for accommodating a label. According to the invention, the body (51) is made from poly(lactic acid).

This invention relates to a label holder for a suspension file, and to a suspension file, equipped with such a label holder.

It is prior art to equip a suspension file with a label holder to accommodate a file identification label. Such a label holder is traditionally made of a synthetic polymer material and usually comprises at least one transparent part designed to protect the label and allow whatever is written on it to be read. This transparent part is typically made of crystal polystyrene, polyethylene or polypropylene, chosen for their good transparency properties. However, in the current context of dwindling oil resources, a label holder made from a polymer synthesized from fossil residues is likely to see its production costs increase significantly. Furthermore, a label holder made of a synthetic polymer is poorly biodegradable.

It is these problems which are more particularly addressed by the invention, which provides a label holder having good transparency in the area where the label is read, yet has a limited manufacturing cost, and in particular a manufacturing cost which is unlikely to increase in the years to come. In addition, this label holder has good biodegradability.

For this purpose, the subject of the invention is a label holder for a suspension file, comprising a body having means for attachment to a side wall of the file and a reader for accommodating a label, wherein the body is made from poly(lactic acid).

Poly(lactic acid) is a natural polymer. For the purposes of the invention, “natural polymer” means any polymer which is not synthesized from fossil resources. In particular, natural polymers as defined in the invention include polymers extracted directly from biomass such as starch, polymers from bioderived monomers such as poly(lactic acid) and polymers produced by micro-organisms such as poly(hydroxyalkanoates).

In accordance with other advantageous features, taken in isolation or in any technically possible combination, of a label holder according to the invention:
the body is made from transparent poly(lactic acid) and has means for retaining a label on one face of the reader;
the body is made from opaque poly(lactic acid), the holder comprising a cover for retaining a label on one face of the reader, which cover is made from a transparent polymer;
the cover is made from a transparent natural polymer;
the body is produced in one piece with the label retaining means;
the body is an injection moulding;
the attachment means comprise attachment tongues, between which is defined a housing for accommodating an edge of a side wall of the file;
the attachment means comprise an attachment flange having fixing members designed to be inserted into holes in a side wall of the file.

The invention also relates to a suspension file comprising a sheet that defines a bottom and two side walls of the file, this file also comprising a label holder as described above, attached to a side wall of the file.

The features and advantages of the invention will become apparent in the course of the following description of two embodiments of a label holder and a suspension file according to the invention. This description is given purely by way of example and refers to the accompanying drawings, in which:

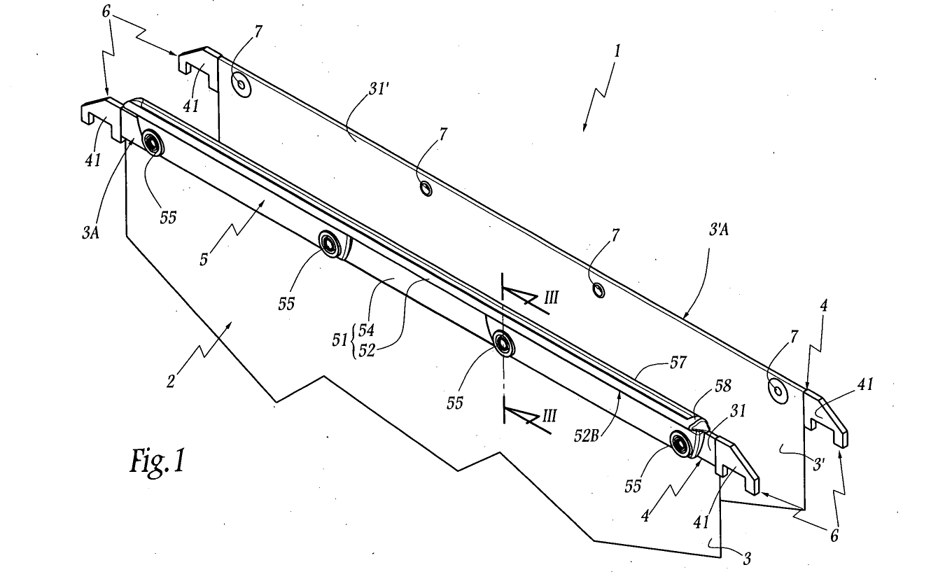

FIG. 1 is a partial perspective view of a suspension file in accordance with a first embodiment of the invention;

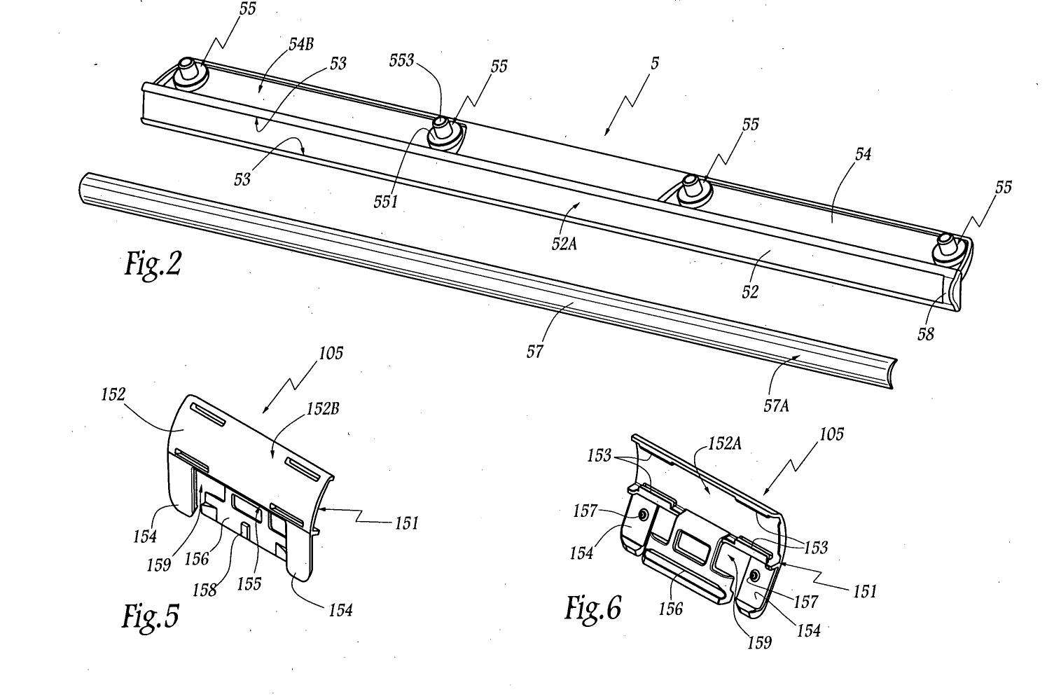

FIG. 2 is an exploded perspective view from another angle of the file label holder seen in FIG. 1;

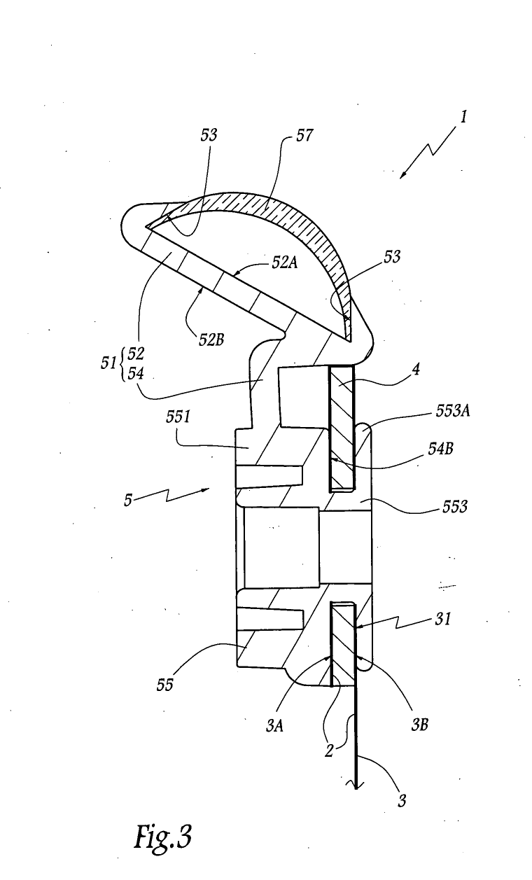

FIG. 3 is a cross section taken on the line marked III-III in FIG. 1;

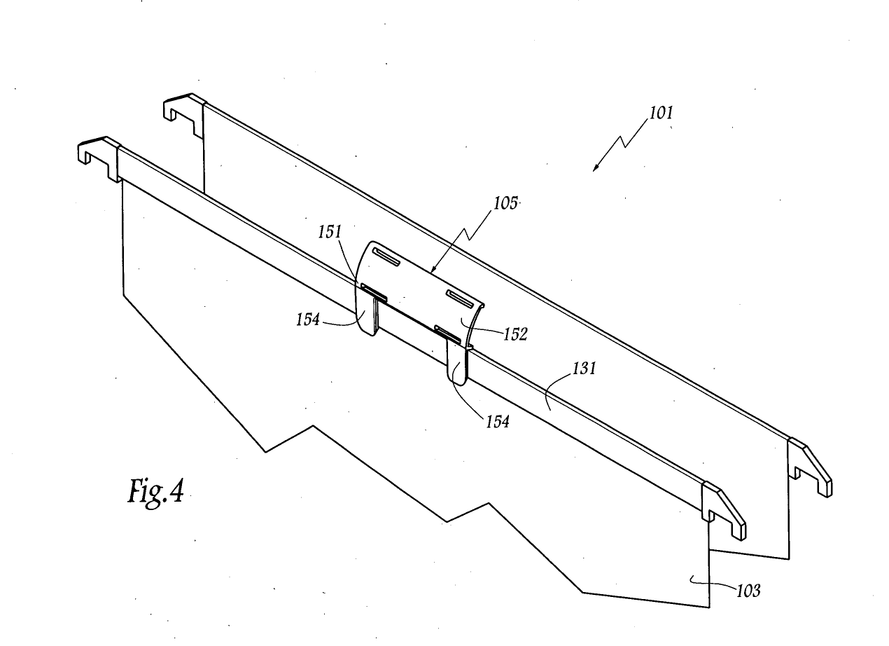

FIG. 4 is a view similar to FIG. 1 for a suspension file in accordance with a second embodiment of the invention;

FIG. 5 is a perspective view from the same angle of the label holder of the file seen in FIG. 4; and

FIG. 6 is a perspective view from another angle of the label holder seen in FIG. 5.

The suspension file 1 shown in FIG. 1 is designed to be installed in a drawer and comprises a sheet 2 that defines a bottom and two side walls 3, 3′ of the file. The file 1 also includes two suspension bars 4 near the edges 31, 31′ of each side wall 3, 3′ remote from the bottom of the file, and a label holder 5 mounted on the remote edge of one of the side walls, specifically side wall 3 in FIG. 1, close to the bar 4 attached to this side wall. The sheet 2 is advantageously made of a paper from forests managed sustainably under the FSC (Forest Stewardship Council) label, or a recycled paper, whereas the suspension bars 4 are made of a mild steel.

Each suspension bar 4 is provided with lateral hooks 41 designed to run on rails (not shown) provided in a drawer in which the file 1 is to be accommodated. Each hook 41 has a nose 6 made advantageously of a recycled and/or natural polymer. The fixing of each bar 4 to the corresponding side wall 3, 3′ is done by folding the sheet 2 around the bar 4 and blocking the sheet 2 in this folded configuration. More specifically, the sheet 2 is immobilized, in the case of the side wall 3 equipped with the label holder 5, by the process of riveting the holder 5 to the side wall 3, and, in the case of side wall 3′, which has no label holder, by means of adhesive. The side wall 3′ which has no label holder also has eyelets 7 passing through the bar 4 and through both sides of the folded sheet 2. Two lateral eyelets 7 in the side wall 3′ also support, in a known manner, the male parts (not shown) of two press-button devices used to connect adjacent suspension files into a continuous chain. These male parts project from an outer face 3′A of side wall 3′.

The label holder 5 shown in FIGS. 1 to 3 has an elongate body 51 comprising a reader 52 and a flange 54 for attaching it to the side wall 3 of the file 1. The reader 52 defines a face 52A on which a label is placed and the attachment flange 54, which is made in one piece with the reader 52, extends from a face 52B of the reader opposite the face 52A. The body 51 is injection-moulded in poly(L-lactic acid) (PLLA), to which colouring pigments are added to give a coloured and opaque body 51. In a variant, the body 51 may be made from a form of poly(lactic acid) other than poly(L-lactic acid).

The label holder 5 also includes a transparent cover 57 for retaining a label on the face 52A. The cover 57 is designed to be slid into longitudinal tracks 53 of the reader 52 in order to cover the face 52A removeably. The reader 52 has a protuberance 58 at one end of the surface 52A, projecting from the face 52A and forming a stop for the cover 57. The outer face 57A of the cover 57 is basically convex, so that the cover 57 forms a magnifier to facilitate reading any writing on a label placed on the face 52A of the reader 52. In this embodiment the cover 57 is made from recycled polyethylene. In a variant, the cover 57 may be made from a transparent natural polymer such as poly(L-lactic acid) not filled with coloured pigments.

The attachment flange 54 of the label holder 5 comprises rivets 55 for fixing the body 51 to the side wall 3. Each rivet 55 has a head 551 formed in the thickness of the attachment flange 54, and a shank 553 projecting from one face 54B of the flange 54 designed to bear against an outer face 3A of the side wall 3. The body 51 is fixed to the side wall 3 by inserting the shank 553 of each rivet 55 into holes in the bar 4 and in the sheet 2 folded around the bar, and then compressing the end 553A of the shank 553 against an inner face 3B of the side wall 3. When the label holder 5 is thus fixed to the side wall 3, the sheet 2 is immobilized in its folded configuration around the bar 4.

As the cross section, FIG. 3, shows, each rivet 55 is hollow. In particular, the lateral rivets 55 of the label holder 5 define openings which form female parts for the two devices used to connect adjacent suspension files into a continuous chain as mentioned earlier. These female parts are suitable for accommodating the male parts formed by the lateral eyelets 7 of another suspension file (not shown), so that these two files can be coupled together.

In the second embodiment shown in FIGS. 4 to 6, parts analogous to those of the first embodiment are given the same reference numbers increased by 100. The label holder 105 of this second embodiment is a tab designed to slip over one edge of a side wall 103 of a suspension file 101, specifically a remote edge 131 of this side wall, as shown in FIG. 4. The label holder 105 comprises a body 151, which has a reader 152 for accommodating a label, and three tongues for attachment to the side wall 103, specifically two lateral tongues 154 and one central tongue 156. These are made in one piece with the reader 152. The reader 152 defines a face 152A on which a label is accommodated, while the face 152B of the reader opposite the face 152A corresponds to the label-reading face. The reader 152 also has four lugs 153 for holding a label flat against the face 152A of the reader.

The attachment tongues 154 and 156 extend from a longitudinal edge 155 of the reader 152 in the same direction as each other, thus forming the arms of a clip. In particular, tongues 154 and 156 define a housing 159 between themselves for accommodating the edge 131 of the side wall 103. Each lateral tongue 154 has an in-turned pin 157 extending towards the central tongue 156, while the central tongue 156 comprises an in-turned projection 158 extending towards the lateral tongues 154. The pins 157 and the projection 158 are designed to provide more efficient clamping of the edge 131 of the side wall 103. The body 151 is injection-moulded in transparent poly(L-lactic acid), the retaining lugs 153, reader 152 and attachment tongues 154 and 156 being all moulded in one piece. In a variant, the body 151 may be made from a form of poly(lactic acid) other than poly(L-lactic acid).

In a variant that is not illustrated, a label holder according to the invention may also comprise a cover, analogous for example to the cover 57 of the first embodiment, mounted permanently on the reader and hinged to the body of the label holder between a closed position, in which the cover lies over the face of the reader designed to accommodate a label, and an open position, in which it gives access to this face. The label holder is then advantageously moulded by twin-shot injection moulding of a transparent natural polymer, such as transparent poly(lactic acid), and opaque coloured poly(lactic acid), so that the cover is transparent while the body of the label holder is coloured, and a hinge is formed integrally in the material between the body and the cover.

A label holder 5 or 105 in accordance with the invention, made at least partly from poly(lactic acid), particularly poly(L-lactic acid) (PLLA), is produced simply by injection moulding. Indeed, poly(L-lactic acid) advantageously has injection moulding processing characteristics that are substantially similar to those of regular polyolefines. Thus, conventional equipment can be used to produce a label holder 5, 105 in accordance with the invention by injection moulding of poly(L-lactic acid).

In addition, a label holder according to the invention, having its body made from poly(lactic acid), has good mechanical properties, adapted both to its utilization and to its attachment to a side wall of a suspension file. In particular, in the first embodiment, the body of the label holder 5, which is made from poly(lactic acid), has a ductile behaviour suited to the attachment of the label holder to a side wall of the file by deforming the rivets 55 of the attachment flange 54.

A label holder 5, 105 in accordance with the invention also has good transparency of its label display parts, which are advantageously made from a natural polymer material. In a particularly advantageous form of the invention, a label holder according to the invention is manufactured entirely in a single piece by injection moulding. Poly(L-lactic acid) is particularly appropriate as the material for such a label holder because of its good transparency. If it is wished to produce a label holder that has not only transparent parts, particularly for displaying the label, but also opaque coloured parts, it is also possible to make a label holder by twin-shot injection moulding of transparent poly(L-lactic acid) and poly(L-lactic acid) filled with coloured pigments.

Furthermore, since poly(lactic acid) can be made indirectly from renewable resources, specifically lactic acid produced by fermenting glucose using various microbial strains, a label holder according to the invention made from poly(lactic acid) is unlikely to suffer a manufacturing cost increase caused by an increase in the cost of its raw material, unlike prior-art label holders made from synthesized polymer using non-renewable fossil resources. Also, given the development of the use of poly(lactic acid) in various fields, especially as a substitute plastic, the quantities of this polymer produced are increasing, suggesting that its cost price may fall. A label holder according to the invention is therefore likely to see its manufacturing cost reduced in the years to come.

A label holder according to the invention, having its Body made from poly(lactic acid), and having other parts, such as the cover 57 in the first embodiment, possibly also made from a natural polymer, has good biodegradability. More specifically, the choice of poly(lactic acid) as the material for the body of the label holder according to the invention makes it possible to obtain, on the one hand, a shelf life of the label holder adapted to its utilization on a suspension file, with good appearance and structure stability of the label holder during its expected use life, and, on the other hand, good biodegradability of the label holder on the long range, after its expected use life. The good biodegradability of the label holder according to the invention, in combination with the choice of biodegradable and/or recycled materials to produce the other components of a suspension file equipped with this label holder, limits the environmental harm of a suspension file in accordance with the invention.

The invention is not limited to the examples described and illustrated. In particular, a suspension file according to the invention can, without departing from the scope of the invention, be a suspension file for something other than a drawer. A label holder according to the invention can thus be designed in such a way as to be able to be mounted on a lateral-type suspension file, in which case the label holder has means for attaching it to a vertical edge of the sheet which constitutes the suspension file.

1. Label holder for a suspension file, comprising a body having means for attachment to a side wall of the file and a reader for accommodating a label, wherein the body is made from poly(lactic acid).

2. Label holder according to claim 1, wherein the body is made from transparent poly(lactic acid) and has means for retaining a label on one face of the reader.

3. Label holder according to claim 1, wherein the body is made from opaque poly(lactic acid), the holder comprising a cover for retaining a label on one face of the reader, which cover is made from a transparent polymer.

4. Label holder according to claim 3, wherein the cover is made from a transparent natural polymer.

5. Label holder according to claim 2, wherein the body is produced in one piece with said label retaining means.

6. Label holder according to claim 3, wherein the body is produced in one piece with said label retaining cover.

7. Label holder according to claim 1, wherein the body is an injection moulding.

8. Label holder according to claim 1, wherein said attachment means comprise attachment tongues, between which is defined a housing for accommodating an edge of a side wall of the file.

9. Label holder according to claim 1, wherein said attachment means comprise an attachment flange having fixing members designed to be inserted into holes in a side wall of the file.

10. Suspension file comprising a sheet that defines a bottom and two side walls of the file, this file also comprising a label holder according to claim 1, attached to a side wall of the file.
